(19) United States
(12) Patent Application Publication
(10) Pub. No.: US 2007/0156685 A1
(43) Pub. Date: Jul. 5, 2007

(54) Method for sorting data using SIMD instructions

(76) Inventors: Hiroshi Inoue, Yokohama City (JP); Takao Moriyama, Yokohama-shi (JP); Hideaki Komatsu, Yokohama-shi (JP)

Correspondence Address: LIEBERMAN & BRANDSDORFER, LLC, 802 STILL CREEK LANE, GAITHERSBURG, MD, 20878, US

(21) Appl. No.: 11/320,095

(22) Filed: Dec. 28, 2005

(51) Int. Cl. G06F 7/00

(52) U.S. Cl. 707/7

(57) ABSTRACT

A method and apparatus are provided to perform fast data sorting by using SIMD instruction. Data comparison and swapping is executed with SIMD instructions in parallel and without conditional branching.

### BACKGROUND OF THE INVENTION

1. Technical Field

This invention relates to sorting data using an SIMD instruction set. More particularly, the invention pertains to an improved efficiency in sorting data sets.

2. Description Of The Prior Art

A sorting algorithm is an algorithm that puts elements of a list in a certain order. Sorting is an integral component of most database management systems (DBMS) and data stream management systems (DSMS). Performance of DBMS and DSMS queries is dominated by the cost of an associated sorting algorithm. Sorting can be both computationally intensive as well as memory intensive. There are many different sorting algorithms. Bubble Sort is one of the most basic sorting algorithms. The Bubble Sort algorithm starts at the beginning of the data set. It compares the first two elements, and if the first is greater than the second, it swaps them. The algorithm continues this form of comparison for each pair of adjacent elements until it reaches the end of the data set. It then starts again with the first two elements, repeating until no swaps have occurred on the last pass. The following is pseudo code for a typical Bubble Sort algorithm:
1. Compare adjacent elements.
2. If the first is greater than the second, swap them.
3. Repeat steps 1 and 2 for each pair of adjacent elements, starting with the first two and ending with the last two. At this point the last element should be the greatest.
4. Keep repeating for one fewer element each time, until you have no more pairs to compare.
   The Bubble Sort algorithm is expensive in that the computational complexity is in the order of O (N²), where O represents the order of the list, and N represents the size of the list.

Another sorting algorithm is known as Comb Sort wherein elements are sorted by comparing and swapping them with other elements further away from them. Comb Sort is a sort algorithm that eliminates small values near the end of the list. In Bubble Sort, when any two elements are compared, they always have a distance from each other of one. The basic idea of Comb Sort is that the gap can be greater than one. Initially, in the Comb Sort algorithm, the gap starts out as the length of the list being sorted divided by a shrink factor, and the list is sorted with that value for the gap. In one embodiment, the shrink factor may be 1.3. Thereafter, the gap is divided by the shrink factor again, and the list is sorted with this new gap. This process repeats until the gap is 1. At this point, Comb Sort performs the final sort in the same manner. The sorting is completed by narrowing the intervals between the elements by degrees. The following is pseudo-code illustrating a typical Comb Sort algorithm:
1. The gap starts out as the length of the list being sorted divided by the shrink factor (generally 1.3; see below)
2. The list is sorted with that value for the gap.
3. The gap is divided by the shrink factor again.
4. The list is sorted with this new gap, and the process repeats until the gap is 1.
5. Return to Step 3 for the final sort.
   On average, the computational complexity of this algorithm is in the range of O (N log N). The Comb Sort repeatedly accesses large memory, as opposed to cache, thereby resulting in a lower cache hit rate.

In the article, “A Cache-Efficient Sorting Algorithm for Database and Data Mining Computations Using Graphics Processors”, by Govindarqju, a sorting algorithm is disclosed which uses single instruction multiple data (“SIMD”) instructions to calculate the minimum and maximum values. Sorting is conducted by using a plurality of SIMD type processors of a graphic processing unit (“GPU”). The computational complexity is in the order of O(N log²N), where O represents the order of, and N represents the size of the list. Based upon the complexity of this algorithm, it is not suitable for a general purpose processor which generally has a fewer number of SIMD type processors than a GPU type processor.

Another sorting algorithm disclosed in Japanese Publication No. 2002-297377 efficiently sorts up to several data sets. However, the algorithm disclosed in the '377 publication is not suitable for sorting a larger data set because the target data is small enough to be contained in a register of the processor, and the computational complexity of the sorting algorithm is in the order of O(N²), where O represents the order of, and N represents the size of the list.

Each of the prior art sorting algorithms shown above have limitations that they are not conducive to efficiently search a large data set. Therefore, there is a need for a fast sorting algorithm wherein the memory access pattern remains constant.

### SUMMARY OF THE INVENTION

This invention comprises a method and computer readable instructions for efficiently sorting a data array.

In one aspect of the invention, a method is provided for efficiently sorting a data array that invokes a Comb Sort algorithm to sort a data set using SIMD instructions. The Comb Sort algorithm uses a combination of min and max instructions, or a combination of compare and select instructions. Following the sorting of the data set, data is swapped based upon a comparison performed in the Comb Sort algorithm.

In another aspect of the invention, an article is provided with a computer useable medium having computer useable program code for sorting a data array. The medium includes computer useable code to invoke a Comb Sort algorithm to sort a data set using SIMD instructions. The code uses either a combination of min and max instructions, or a combination of compare and select instructions. In addition, computer useable code is provided to swap data based upon a comparison performed in the Comb Sort algorithm.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block showing data placement in memory.

FIG. 2a is a block diagram showing a vector_cmpswap operation between two vectors.

FIG. 2b is a block diagram showing a vector_smpswap_skew operation between two vectors.

FIG. 3a is a block diagram showing a vector_swap4 operation between two vectors.

FIG. 3b is a block diagram showing a vector_swap2 operation between two vectors.

FIG. 4 is a block diagram showing placement of keys in memory.

FIG. 5 is a block diagram showing placement of keys and data in memory according to the preferred embodiment of this invention, and is suggested for printing on the first page of the issued patent.

FIG. 6 is a graph showing a comparison of the Comb Sort algorithm with the Quick Sort algorithm, both using VMX instructions.

### DESCRIPTION OF THE PREFERRED EMBODIMENT

### Technical Details

An instruction set, or instruction set architecture (ISA), describes the aspects of a computer architecture visible to a programmer, including the native data types, instructions, registers, addressing modes, memory architecture, interrupt and exception handling, and external I/O (if any). The ISA is a specification of the set of all binary codes that are the native form of commands implemented by a particular CPU design. The set of binary codes for a particular ISA is also known as the machine language for that ISA.

VMX is a floating point and integer SIMD instruction set implemented on versions of the PowerPC. It features 128-bit vector registers that can represent sixteen 8-bit signed or unsigned characters, eight 16-bit signed or unsigned shorts, four 32-bit integers or four 32-bit floating point variables. VMX provides cache-control instructions intended to minimize cache pollution when working on streams of data. SIMD instruction sets can batch process a plurality of data sets that are consecutive in memory. However, as noted above, VMX memory access is limited to 128 bit aligned consecutive boundaries. Therefore, it is difficult to implement fast sorting by using VMX with certain sort algorithms which have memory access patterns dependent on the data and are not aligned to 128 bit boundaries.

In one embodiment, data is sorted using VMX with a Comb Sort algorithm since memory access pattern in this algorithm is not dependent on the data and always stays consecutive. The following instructions sets in VMX are utilized with the Comb Sort algorithm: min instructions, max instructions, compare instructions, select instructions, and permutation instructions. The min, max and compare instructions each use two 16 byte VMX registers for input, one VMX register for output, and handles data from the 16 byte VMX registers as four 32 bit integer strings from slot 1 to slot 4. The min instructions compare values from each slot in the two input registers. Following the comparison, the min instructions outputs the smaller value to the corresponding slot in the output register.

The min instruction (vec_min) outputs the smaller of the 1 st elements of the two input registers to the 1 st slot of the output register, and so on. The max instruction (vec_max) outputs the greater value from each slot. The compare instruction (vec_cmpgt) compares values of each slot. If the value of the first input register is greater, the compare instruction makes all bits in the corresponding slot of the output register 1. Similarly, if the value of the input registers are equal or the value of the second input register is greater, the compare instruction makes all bits in the corresponding slot of the output register 0.

The select instruction (vec_sel) uses three registers for input and one register for output. For each bit in the output register, if the bit which corresponds to the third argument is 0, the select instruction outputs the bit which corresponds to the first argument. Similarly, if the bit which corresponds to the third argument is 1, the select instruction outputs the bits which corresponds to the second argument. Finally, the permutation instruction (vec_perm) also uses three registers for input and one register for output. The permutation instruction handles data in the registers as 16 single byte strings. The instruction first creates 32 single byte strings by combining the first argument with a second argument, in that order, and returns a byte value of the position indicated by the values of the lowest 5 bits in each element of the third argument as the return value of the position corresponding to that element.

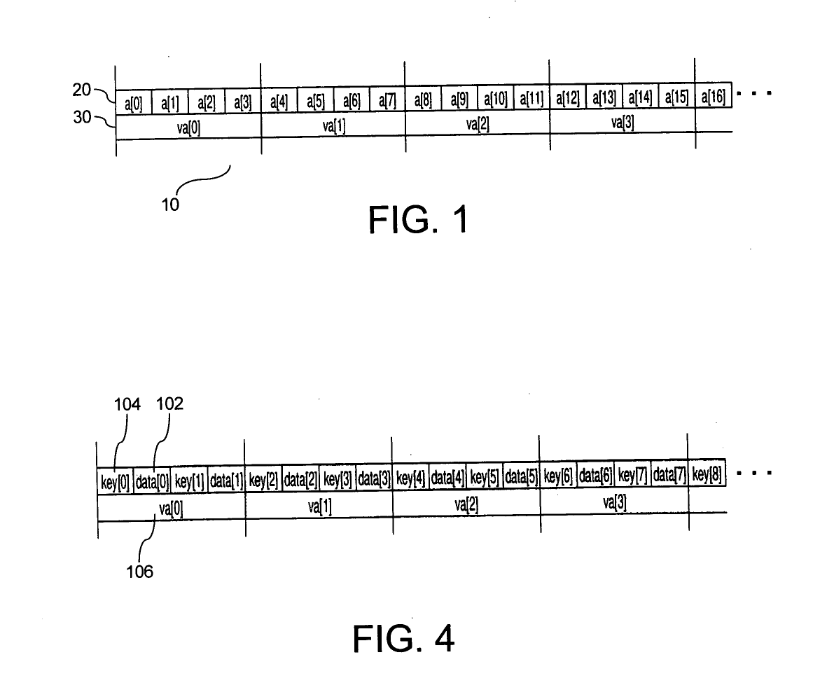

In one embodiment, a vector set is provided where a single vector consists of four integer data sets. FIG. 1 is a block diagram (10) showing an example of data placement in memory, where a[i] is a data set (20), and va[i] is a vector set (30). A vector integer element va[I] consists of four integer values of a[I*4] to a[I*4+3]. The basic operation of the Comb Sort is data swapping. The following is pseudo code showing a portion of the sorting algorithm for implementation of the comparing and swapping of the vector and integer sets shown in FIG. 1 with VMX instructions:

tmp = va[0];
va[0] = vec_min (va[0], va[1]);
va[1] = vec_max (tmp, va[1]);

The following is pseudo code for the comparing and swapping of the vector and integer sets shown in FIG. 1 without VMX instructions:

if (a[0] > a[4]) swap (a[0], a[4]);
if (a[1] > a[5]) swap (a[1], a[5]);
if (a[2] > a[6]) swap (a[2], a[6]);
if (a[3] > a[7]) swap (a[3], a[7]);

There are two advantages to use VMX instructions. First, the VMX instructions can process four data pairs in parallel. Second, the VMX instructions can process data without using conditional branches.

After executing Comb Sort on the vector integer array va[ ] using compare and swap operations with VMX instructions, the values are sorted in the following four independent series: a[4n], a[4n+1], a[4n+2], a[4n+3], provided n is 0, 1, 2, . . . , (N/4)−1. After sorting data in each series, the sorted series is merged so all of the data is sorted. Although the merging process has a small order of computational complexity, it is a comparison process which includes a penalty for incorrect branching prediction and processing time. In one embodiment, the Comb Sort algorithm may be modified to omit conditional branches in this merging process by introducing additional operations. The following is pseudo code showing the modified Comb Sort algorithm.

gap = (N/4 * 10) / 13;
while (gap > 1) {

/* comparison within each series */
for (j = 0; j < N/4 - gap; j++)

vector_cmpswap(va[j], va[j+gap]);

/* comparison between neighbor series */
k = N/4 - gap + 1;
for (j = 0; j< N/4 - k; j++)

vector_cmpswap_skew(va[j], va[j+k]);

/* dividing gap by the shrink factor */
gap = (gap * 10) / 13;

}
do {

cont = 0;
/* comparison within each series */
for (j = 0; j < N/4 - 1; j++) {

vaj0 = va[j];
vector_cmpswap(va[j], va[j+1]);
cont |(vaj0 != va[j]);

}
/* comparison between neighbor series */
vaj0 = va[0];
vector_cmpswap_skew(va[0], va[N/4−1]);
cont |= (vaj0 != va[0]);

} while(cont);

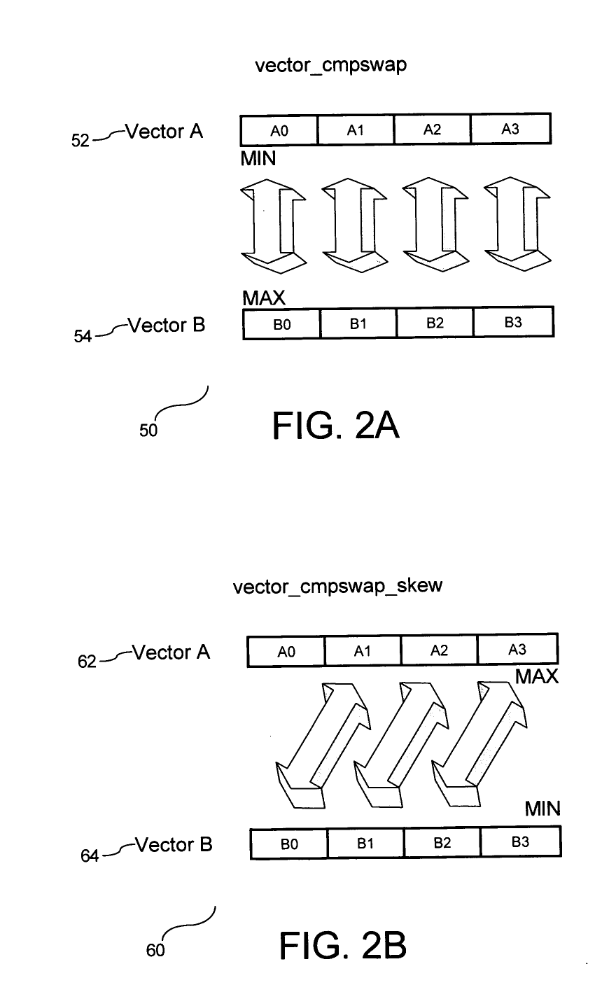

These additional operations compare two values in distinct series. In this pseudo code, vector_cmpswap is an operation that compares and swaps values in each element of one vector with a corresponding element of another vector. FIG. 2a is a block diagram (50) showing a vector_cmpswap operation between vector a[ ] (52) and vector b[ ] (54) using min and max instructions. Similarly vector_cmpswap_skew is a operation that compares and swaps second to fourth elements of a vector with first to third elements of another vector. FIG. 2b is a block diagram (60) showing a vector_cmpswap_skew operation between vector a[ ] (62) and vector b [ ] (64) using the min and max instructions. In addition to the data being sorted inside each vector series, the last data in the first series is guaranteed to be smaller than the first data in the second series. Similarly, the values in the third series is guaranteed to be greater than the values in the second series, and the values in the fourth series is guaranteed to be greater than the values in the third series. As a result, an example array will be sorted in the following order: a[0], a[4], a[8], . . . a[N−4], a[1], a[5], . . . a[N−3], a[2], a[6], . . . a[n−2], a[3], a[7], . . . a[N−1]. Only the data movement without conditional branching, i.e. does not require a selection from one of two divergent paths, is able to sort the above array correctly. Without the penalty associated with incorrect branch prediction, the operation is completed faster than the merging process with conditional branching.

When we add vector_cmpswap_skew operations in the Comb Sort, a small value sometimes appears near the last element of a sequence due to a vector_cmpswap_skew operation. Such a value may degrade the performance of the sorting. In order to avoid this, we introduce a preconditioning phase before the sorting. The following is pseudo code showing the preconditioning algorithm.

for (i = 0; i < N/4 − 1; i++) {

vector_cmpswap(va[i], va[i+1]);
vector_swap4(va[i], va[i+1]);
vector_cmpswap(va[i], va[i+1]);
vector_swap2(va[i], va[i+1]);

}

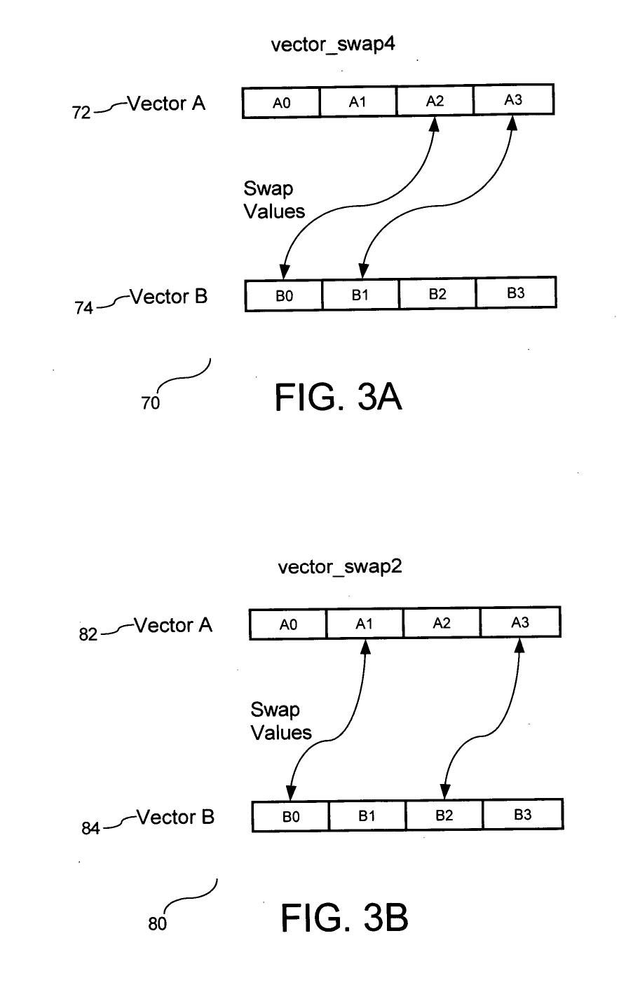

FIG. 3a is a block diagram (70) showing a vector_swap4 operation between vector a [ ] (72) and vector b [ ] (74) used in the pseudo code, and FIG. 3b is a block diagram (80) showing a vector_swap2 operation between vector a [ ] (82) and vector b [ ] (84). In one embodiment, the data is rearranged within the vector so that the data becomes larger by degree as it goes from slot 1 to slot 4 within each vector. This process reduces the frequency of the data shifting across multiple series during a Comb Sort algorithm.

As discussed above, the Comb Sort instruction may be used for efficiently sorting simple integer type data arrays. However, with respect to a database, the sorting method may include a data structure and associated keys, which generally exceeds the 32 bit data limit of the VMX instructions. In one embodiment, if the sorting involves any additional data other than the keys, the keys may be set in the upper 32 bits, and additional data, such as pointers, may be set in the lower 32 bits. FIG. 4 is a block diagram (100) showing an example of placement of keys and data inside memory. As shown, data (102) is stored together with its associated key (104) in a vector (106) arrangement. Sorting of {key,data} pairs is conducted based upon the value of the key without conditional branching. The following is pseudo code demonstrating the sorting of the {key,data} pairs:

pattern = {0x00, 0x01, 0x02, 0x03, 0x00, 0x01, 0x02, 0x03, 0x08,

0x09, 0x0A, 0x0B0, 0x08, 0x09, 0x0A, 0x0B};

tmp = va[0];
mask = vec_cmpgt (va[0], va[1]);
mask = vec_perm (mask, mask, pattern);
va[0] = vec_sel (va[0], va[1], mask);
va[1] = vec_sel (va[1], tmp, mask);

Where, the vec_perm instruction copies the comparison results of the keys included in slot 1 and slot 3 to slot 2 and slot 4, respectively, thereby ensuring that data is always moved according to the comparison results of the keys.

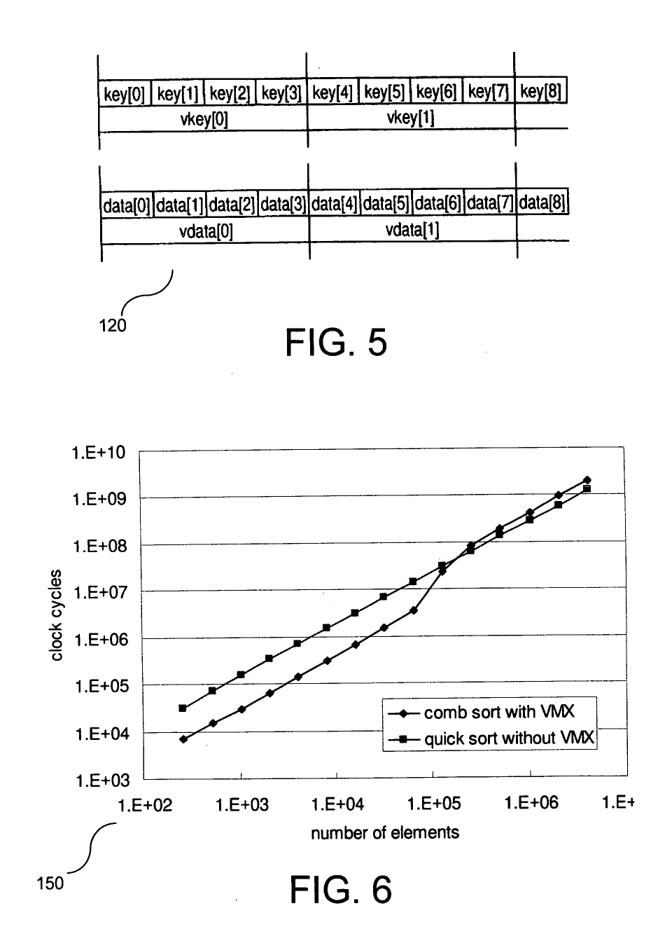

FIG. 5 is a block diagram (120) showing an example of placement of keys and data inside memory. When the keys and additional data are placed in the independent memory space, sorting can be performed by moving both keys and data using masks from the comparison results of the key array. The following is pseudo code demonstrating this sorting:

tmp = vkey[0];
mask = vec_cmpgt (vkey[0], vkey[1]);
vkey[0] = vec_sel (vkey[0], vkey[1], mask);
vkey[1] = vec_sel (vkey[1], tmp, mask);
tmp = vdata[0];
vdata[0] = vec_sel (vdata[0], vdata[1], mask);
vdata[1] = vec_sel (vdata[1], tmp, mask);

Use of the Comb Sort algorithm with the VMX instructions as shown herein rapidly processes a data set if the data set can be fully stored in the cache of the processor. However, if data exceeds the size of the cache, the cache hit rate is reduced since some of the data set is not quickly accessible from the cache as it is stored in an alternative memory location. This results in lowered performance.

For sorting large data, the Comb Sort algorithm may be combined with a Quick Sort algorithm, or with a Merge Sort algorithm. The Quick Sort algorithm employs a divide and conquer strategy to divide a list into two sub-lists. The following is pseudo code for the Quick Sort algorithm:
1. Pick an element, called a pivot, from the list.
2. Reorder the list so that all elements which are less than the pivot come before the pivot and so that all elements greater than the pivot come after it (equal values can go either way). After this partitioning, the pivot is in its final position. This is called the partition operation.
3. Recursively sort the sub-list of lesser elements and the sub-list of greater elements.
   The base case of the recursion are lists of size zero or one, which are always sorted. The algorithm always terminates because it puts at least one element in its final place on each iteration. Generally, once the data size is reduced with the Quick Sort algorithm, another algorithm is invoked to achieve higher performance. If Comb Sort in the present invention is invoked, the switching between algorithms is done while the number of elements is far greater.

In one embodiment, the Comb Sort algorithm can be combined with a Merge Sort algorithm in place of the Quick Sort algorithm. Merge Sort is a sorting algorithm for rearranging lists (or any other data structure that can only be accessed sequentially, e.g. file streams) into a specified order. The following is pseudo code for the Merge Sort algorithm:
1 Divide the unsorted list into two sublists of about half the size
2. Sort each of the two sublists
3. Merge the two sorted sublists back into one sorted list.
   In the case of a Merge Sort algorithm, the data is divided into chunks small enough to fit in the cache memory prior to initiating the algorithm. Each chunk is sorted with the method of the present invention, and then merged. This method is efficient in a multiprocessor system wherein each chunk of data can be sorted simultaneously in a plurality of processors.

The following is an example of implementation of the invention. FIG. 6 is a graph (150) charting a comparison of the Comb Sort algorithm using VMX instructions with the Quick Sort algorithm without VMX instructions. The horizontal axis indicates the number of elements, and the vertical axis indicates the number of clock cycles required for sorting. As shown, the Comb Sort algorithm is affected by the cache size. Its performance degrades starting at 100,000 elements.

The invention can take the form of a hardware embodiment, a software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

### Advantages Over the Prior Art

The implementation of the Comb Sort using the embodiments illustrated above is extremely fast if data is contained in the cache of the processor. For sorting large data, the Comb Sort algorithm may be combined with the Quick Sort algorithm to provide enhanced performance. The Comb Sort algorithm may also be combined with the Merge Sort algorithm. For example, the data may be divided into groups small enough to fit in the cache memory. By sorting each group with the Comb Sort algorithm followed by merging the groups, performance degradation caused by incorrect cache can be mitigated. In an embodiment utilizing a plurality of processors, each group of data may be sorted simultaneously in a plurality of processors.

### ALTERNATIVE EMBODIMENTS

It will be appreciated that, although specific embodiments of the invention have been described herein for purposes of illustration, various modifications may be made without departing from the spirit and scope of the invention. In particular, a different instruction set may be substituted in place of the VMX instruction set, such as the SPU instruction set of the Cell Broadband Engine architecture. Similarly, while the data type of the array to be sorted is explained on the assumption of the 32-bit integer, the present invention can be implemented using other data types. For example, VMX has the necessary instructions for 32 bit floating point data, thus, it can sort 32 bit floating point data as well as the 32 bit integer data. Similarly, the invention is not limited to 32-bit data or 128-bit vector register. This invention to other data types supported by the instruction set.

Accordingly, the scope of protection of this invention is limited only by the following claims and their equivalents.

We claim:

1. A method for sorting a data array comprising:
invoking a comb sort algorithm for sorting a data set using a combination of SIMD instructions selected from a group consisting of: min and max instructions, and compare and select instructions;
swapping data based upon a comparison in said algorithm.

2. The method of claim 1, further comprising invoking an inter-slot data comparison process followed by a data swapping.

3. The method of claim 1, further comprising invoking a quick sort algorithm to reduce data size.

4. The method of claim 1, further comprising dividing said data sets into a plurality of groupings prior to invoking said comb sort algorithm.

5. The method of claim 4, further comprising invoking a merge sort algorithm to combine said groupings upon completion of the step of swapping said data.

6. The method of claim 1, wherein
said data set is a data structure, and said data structure includes keys and additional data; and
further comprising applying a permutation instruction to a key comparison result obtained through parallel compare and select instructions of said comb sort algorithm.

7. The method of claim 1, wherein
said data set is a data structure, and said data structure includes keys and additional data; and
further comprising applying results of key comparison obtained by parallel compare instructions to other data.

8. An article comprising:
a computer useable medium having computer useable program code for sorting a data array, said medium comprising:
computer useable code for invoking a comb sort algorithm to sort a data set using a combination of SIMD instructions selected from a group consisting of: min and max instructions, and compare and select instructions;
computer useable code for swapping data based upon a comparison in said algorithm.

9. The article of claim 8, further comprising computer useable code for invoking an inter-slot data comparison process followed by a data swapping.

10. The article of claim 8, further comprising computer useable code for invoking a quick sort algorithm to reduce data size.

11. The article of claim 8, further comprising computer useable code for dividing said data sets into a plurality of groupings prior to invoking said comb sort algorithm.

12. The article of claim 11, further comprising computer useable code for invoking a merge sort algorithm to combine said groupings upon completion of the computer useable code for swapping said data.

13. The article of claim 8, wherein
said data set is a data structure, and said data structure includes keys and additional data; and
further comprising computer useable code for applying a permutation instruction to a key comparison result obtained through parallel compare and select instructions of said comb sort algorithm.

14. The article of claim 8, wherein
said data set is a data structure, and said data structure includes keys and additional data; and
further comprising computer useable code for applying results of key comparison obtained by parallel compare instruction to other data.

15. The article of claim 8, wherein the medium is a recordable data storage medium.
